(19) United States
(12) Patent Application Publication
(10) Pub. No.: US 2007/0085672 A1
(43) Pub. Date: Apr. 19, 2007

(54) VACUUM SYSTEM AND WARNING METHOD THEREOF

(76) Inventor: Hung-Huang Hsu, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/163,395

(22) Filed: Oct. 17, 2005

(51) Int. Cl. G08B 19/00; F27D 7/06; G08G 1/16; G08B 21/00

(52) U.S. Cl. 340/521; 373/112; 373/141; 340/679; 701/301

(57) ABSTRACT

A vacuum system suitable for a semiconductor process is provided. The vacuum system includes a plurality of devices, a plurality of sensors and a warning/control unit. The sensors are respectively disposed in these devices for performing sensing and they output a plurality of sensing values. The warning/control unit is electrically connected both with the devices and the sensors, and receives the sensing values output from the sensors. Wherein, the warning/control unit transmits a warning signal when a first condition is satisfied; otherwise, it transmits a terminating signal when a second condition is satisfied.

### BACKGROUND OF THE INVENTION

1. Field of Invention

The present invention relates to a vacuum system. More particularly, it relates to a vacuum system having a warning capability.

2. Description of Related Art

With the rapid development of the semiconductor industries and electronic techniques in recent years, electronic products having more powerful and superior functions are constantly being manufactured. In general, certain semiconductor processes including thin film deposition, etching, ion implantation and lithography, are performed to provide the semiconductor materials with specific electrical characteristics. The devices for performing the semiconductor processes usually need to be operated under suitable gas pressure, which is maintained by a vacuum system. In other words, the vacuum system is used to supply an ambience with a high vacuum state (i.e. low gas pressure). Accordingly, the semiconductor processes can be performed under the specific gas ambience so as to provide the silicon wafer with the proper physical and chemical mechanisms. During a semiconductor process, control and management of vacuum conditions for the devices or chambers of the vacuum system are required to prevent the silicon wafer from being contaminated and thereby the production yield damaged. Traditionally, in order to enable the devices of the vacuum system to operate normally under the set ranges, manpower is provided for checking regularly all devices of the vacuum system and shutting them down when abnormal situations happen.

Yet, since appropriate warnings for the traditional vacuum system rely on manpower to perform regular checking, not only labor cost required is high but abnormal situations of devices cannot be reacted to and resolved dynamically. Hence, in terms of warning functions, the traditional vacuum system is insufficient and uneconomical.

### SUMMARY OF THE INVENTION

In view of these limitations, one object of the present invention is to provide a vacuum system suitable for a semiconductor process to improve the warning function of the traditional vacuum system and save costs.

Another object of the present invention is to provide a vacuum system with a warning method suitable to provide the vacuum system with a dynamic warning function.

To achieve these and other advantages and in accordance with the purpose of the invention, as embodied and broadly described herein, the invention provides a vacuum system suitable for a semiconductor process. The vacuum system comprises a plurality of devices, a plurality of sensors and a warning/control unit. The sensors are respectively disposed in the devices. The sensors are used to perform sensing, and they output a plurality of sensing values. The warning/control unit is electrically connected with the devices and the sensors so as to receive sensing values from the sensors. The warning/control unit transmits a warning signal when a first condition is satisfied; otherwise, the warning/control unit transmits a terminating signal when a second condition is satisfied.

According to one embodiment of the present invention, the devices comprise a reaction chamber and a negative-pressure system, for example.

According to one embodiment of the present invention, the devices further comprise a scrubber, a pump and a buffer reaction chamber.

According to one embodiment of the present invention, one of the sensors comprises a temperature sensor, a pressure sensor, a gas flowmeter, and a Voltmeter or an Ammeter.

According to one embodiment of the present invention, the aforesaid first condition can occur when one of the sensing values exceeds a corresponding set range.

According one embodiment of the present invention, the aforesaid second condition can occur when at least two of the sensing values exceed corresponding set ranges.

According to one embodiment of the present invention, the said terminating signal can stop the operation of one of the devices.

According to one embodiment of the present invention, said terminating signal can stop the operation of all of the devices in order to terminate the vacuum system.

According to one embodiment of the present invention, the warning/control unit comprises a programmable logic controller (PLC).

According to one embodiment of the present invention, the warning/control unit comprises a central processing unit (CPU).

To achieve these and other advantages and in accordance with the purpose of the invention, as embodied and broadly described herein, the invention further provides a warning method for a vacuum system, suitable for a semiconductor process. The warning method for a vacuum system is comprised as follows. First, a plurality of sensors which are respectively disposed in a plurality of devices of a vacuum system are provided to obtain a plurality of sensing values, and these sensing values are output. Then, a warning/control unit is provided to electrically connect with the sensors and devices to receive the sensing values obtained by the sensors. The sensing values can be temperature value, pressure value, gas flowrate, voltage value or current value. When the first condition, which occurs when one of the sensing values exceeds the corresponding set value range, is satisfied, the warning/control unit transmits a warning signal. When the second condition, which occurs when at least two of the sensing values exceed the corresponding set value ranges, is satisfied, the warning/control unit transmits a terminating signal.

According one embodiment of the present invention, the warning/control unit can comprise a programmable logic controller (PLC).

According one embodiment of the present invention, the warning/control unit can comprise a central processing unit (CPU).

Based on the above descriptions, the vacuum system of the present invention utilizes a warning/control unit and sensors to receive the sensing values obtained by the sensors to determine whether the devices of the vacuum system operate normally, so that operation of the vacuum system can be dynamically monitored, providing an effective warning and controlling system. In addition, by utilizing the warning method for a vacuum system according to the present invention, the cost of controlling and managing the vacuum system can be reduced.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows the vacuum system according to one embodiment of the present invention.

FIG. 2 schematically illustrates the warning method of a vacuum system according to another embodiment of the present invention.

### DESCRIPTION OF THE EMBODIMENTS

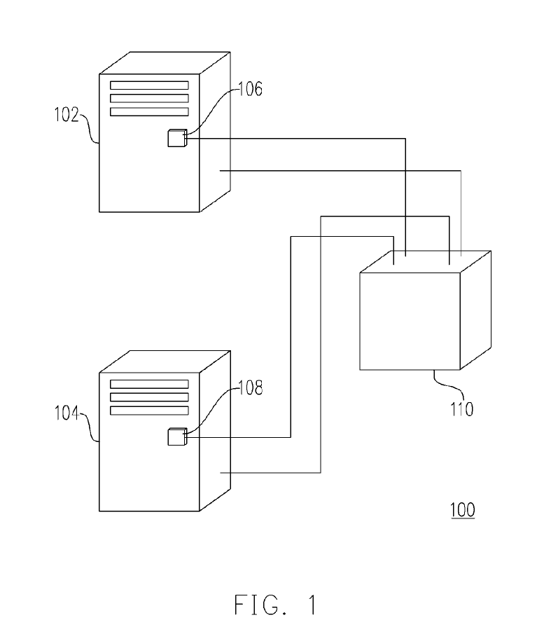

FIG. 1 schematically shows the vacuum system according to one embodiment of the present invention. In FIG. 1, the vacuum system 100 of the present embodiment is utilized to provide the gaseous ambience required to perform a semiconductor process. The semiconductor process can be an etching process, an exposure process, a deposition process or an ion implantation. The vacuum system 100, for example, comprises a first device 102, a second device 104, a first sensor 106, a second sensor 108 and a warning/control unit 110, wherein the first sensor 106 and the second sensor 108 are respectively disposed in the first device 102 and the second device 104, and they are electrically connected with the warning/control unit 110 respectively. The first sensor 106 and the second sensor 108 are utilized to perform the sensing of the operating state of the first device 102 and the second device 104, and to obtain and output the sensing values. The warning/control unit 110, which is electrically connected with the first device 102 and the second device 104 respectively, receives these sensing values output from the sensors 106 and 108. Further, the warning/control unit 110 transmits a waning signal when a first condition is satisfied, and transmits a terminating signal when a second condition is satisfied.

In the present embodiment, the first device 102 and the second device 104 can be a reaction chamber and a negative-pressure system. The first sensor 106 and the second sensor 108 can be a temperature sensor and a pressure sensor correspondingly to perform the sensing of the temperature for the first device 102 and the sensing of the pressure for the second device 104. The warning/control unit 110 then receives the sensing values obtained by the sensors 106 and 108. According to the embodiment of the present invention, the warning/control unit 110 can be a programmable logic controller (PLC) or a central processing unit (CPU). The warning/control unit 110 is utilized to integrate the sensing values indicating the current states for every device by receiving the sensing values sent back by the sensors and to determine whether the devices are abnormal or not.

More specifically, the sensors 106 and 108 are used for sensing operating states or ambient conditions of the semiconductor process for devices 102 and 104 and getting sensing values, and these sensing values are simultaneously transmitted to the warning/control unit 110. After receiving the sensing values from sensors 106 and 108, the warning/control unit 110 determines whether the first condition or the second condition is satisfied. For example, the first condition can occur when the sensing value(s) of at least one device exceeds or exceed the set operating states or ambient conditions, and the second condition can occur when the sensing values of at least two devices exceed the set operating states or ambient conditions. Based on the descriptions above, for the present embodiment when the temperature sensing value for the first device 102 exceeds the corresponding set range, or when the pressure sensing value for the second device 104 exceeds the corresponding set range, the warning/control unit 110 determines that the first condition is satisfied and transmits a warning signal. Otherwise, when the temperature sensing value for the first device 102 and the pressure sensing value for the second device 104 both exceed the corresponding set ranges, the warning/control unit 110 determines that the second condition is satisfied and transmits a terminating signal for stopping operation of devices 102, 104 and terminating the vacuum system 100. Thus, the process is halted. Note that the conditions which are set for determining the situation of the vacuum system depend on the requirements of processes, and the first and second condition herein are exemplary and are not intended to limit the present invention.

It is worthy to note that, though the vacuum system 100 in the present embodiment includes the first device 102 and second device 104, the vacuum system according to the embodiment of the present invention can comprise a plurality of devices including a scrubber, a pump, a buffer reaction chamber, and so on. Also, said devices are equipped with corresponding sensors. During the fabricating process, the sensor of each device performs the sensing of ambient conditions and outputs obtained sensing values to the warning/control unit 110. Therefore, the warning/control unit 110 can receive all sensing values from sensors at the same time, determining whether operating states and ambient conditions for the devices of the vacuum system 100 are normal.

It is also worthy to note that the vacuum system 100 comprises a plurality of devices, and that not just one sensor can be disposed in each device for obtaining one sensing value, but also multiple sensors can be disposed in each device for obtaining sensing values of various types. For example, the first device 102 can be fitted with a temperature sensor and a pressure sensor for obtaining sensing values of temperature and pressure, and those sensing values are transmitted to the warning/control unit 110 for determining whether operating of the vacuum system 100 is normal.

Hence, the vacuum system according to the present invention has a better ability to warn, and thereby to provide effective control and management of the process conditions required, allowing the semiconductor processes to be performed under correct gaseous ambience.

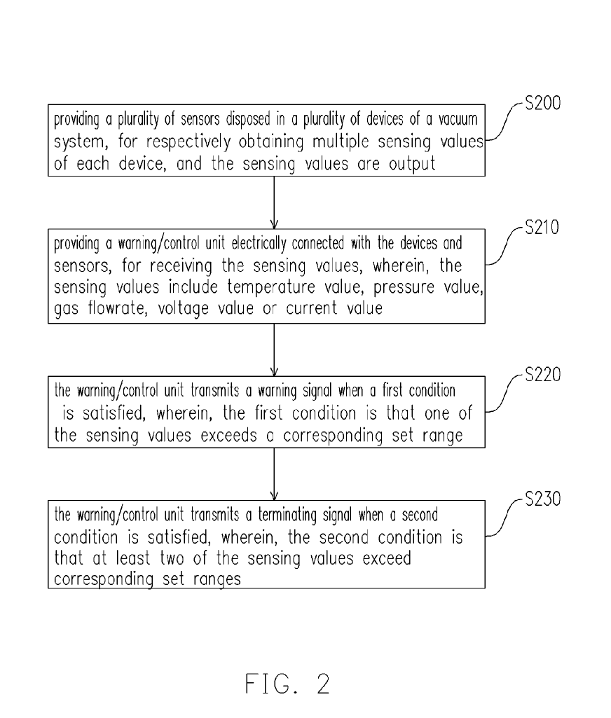

FIG. 2 schematically illustrates the warning method for a vacuum system according to another embodiment of the present invention. Referring to FIG. 2, firstly a plurality of sensors which are respectively disposed in a plurality of devices of a vacuum system are provided for obtaining a plurality of sensing values, and these sensing values are output. The sensing values can be temperature values, pressure values, gas flowrates, voltage values or current values at the step of S200. Later, at the step of S210, a warning/control unit is provided for receiving the sensing values obtained by the sensors. At this step S210, the warning/control unit simultaneously receives all sensing values and performs the determination of the set conditions. When the first condition, which occurs when one of the sensing values exceeds the corresponding set range for example, is satisfied, the warning/control unit transmits a warning signal indicating that an abnormal state for one device has appeared. Otherwise, when the second condition, which occurs when at least two of the sensing values selected exceed the corresponding set ranges for example, is satisfied, the warning/control unit transmits a terminating signal indicating that abnormal states have occurred at least two devices have resulted in a seriously abnormal operation of the vacuum system. Accordingly, the operation of the vacuum system is terminated. Note that said set ranges depend on the requirements of the fabricating process executed, and are not confined by the embodiments of the present invention herein.

To sum up, the vacuum system based on the present invention possesses at least the following advantages.

1. The vacuum system of the present invention utilizes a warning/control unit and sensors to integrate the operating states or the ambient conditions of all devices and perform dynamic warnings. By doing so, abnormal situations of the vacuum system can be effectively monitored and controlled.

2. By utilizing the present invention's vacuum system with warning capability, the cost of control and management can be reduced.

3. The warning method for a vacuum system basing on the present invention is capable of reducing the cost required and providing the vacuum system with dynamic warning capability.

It will be apparent to those skilled in the art that various modifications and variations can be made to the structure of the present invention without departing from the scope or spirit of the invention. In view of the foregoing descriptions, it is intended that the present invention cover modifications and variations of this invention if they fall within the scope of the following claims and their equivalents.

What is claimed is:

1. A vacuum system suitable for a semiconductor process, comprising:
a plurality of devices;
a plurality of sensors disposed in the devices respectively, the sensors performing sensing functions and outputting a plurality of sensing values; and
a warning/control unit, electrically connected with the devices and the sensors, the warning/control unit being used for receiving sensing values from the sensors, wherein the warning/control unit transmits a warning signal when a first condition is satisfied; and the warning/control unit transmits a terminating signal when a second condition is satisfied.

2. The vacuum system as claimed in claim 1, wherein the devices comprise a reaction chamber and a negative-pressure system.

3. The vacuum system as claimed in claim 2, further comprising a scrubber, a pump and a buffer reaction chamber.

4. The vacuum system as claimed in claim 1, wherein one of the sensors includes a temperature sensor, a pressure sensor, a gas flowmeter, and a Voltmeter or an Ammeter.

5. The vacuum system as claimed in claim 1, wherein the first condition includes one of the sensing values exceeding a set range correspondingly.

6. The vacuum system as claimed in claim 1, wherein the second condition includes at least two of the sensing values selected exceeding set ranges correspondingly.

7. The vacuum system as claimed in claim 1, wherein the terminating signal is used to stop the operation of one of the devices.

8. The vacuum system as claimed in claim 1, wherein the terminating signal is used to stop the operation of all the devices, thus halting the vacuum system.

9. The vacuum system as claimed in claim 1, wherein the warning/control unit comprises a programmable logic controller (PLC).

10. The vacuum system as claimed in claim 1, wherein the warning/control unit comprises a central processing unit (CPU).

11. A warning method for a vacuum system, comprising:
a plurality of sensors disposed in a plurality of devices, for obtaining multiple sensing values for each device respectively and outputting the sensing values;
a warning and control unit electrically connected with the devices and sensors, for receiving the sensing values, wherein one of the sensing values is temperature value, pressure value, gas flowrate, voltage value or current value;
the warning and control unit transmitting a warning signal when a first condition is satisfied, the first condition occurring when one of the sensing values exceeds a corresponding set range; and
the warning and control unit transmitting a terminating signal when a second condition is satisfied, the second condition occurring when at least two of the sensing values selected exceed corresponding set ranges.

12. The vacuum system as claimed in claim 11, wherein the warning/control unit comprises a programmable logic controller (PLC).

13. The vacuum system as claimed in claim 11, wherein the warning/control unit comprises a central processing unit (CPU).
